(19) United States
(12) Patent Application Publication
(10) Pub. No.: US 2020/0363958 A1
(43) Pub. Date: Nov. 19, 2020

(54) EFFICIENT RECOVERY OF RESILIENT SPACES

(71) Applicant: Microsoft Technology Licensing, LLC, Redmond, WA (US)

(72) Inventors: Karan MEHRA, Sammamish, WA (US); Justin Sing Tong CHEUNG, Redmond, WA (US); Vinod R. Shankar, Redmond, WA (US)

(21) Appl. No.: 16/413,459

(22) Filed: May 15, 2019

(51) Int. Cl. G06F 3/06; G06F 11/10; G06F 11/16; G06F 11/30

(52) U.S. Cl. CPC G06F 3/065; G06F 3/0619; G06F 11/1092; G06F 3/067; G06F 3/0644; G06F 11/3055; G06F 11/1662

(57) ABSTRACT

A first storage device configured to store data associated with a user is allocated. The data stored on the first storage device is mirrored at a second storage device. A resiliency mechanism is implemented at the first and second storage devices. The first and second storage devices are associated with a unit of allocation. When the second storage device is not available, a data structure is instantiated that is configured to track which subunits of the first and second storage devices have been modified. The data structure is updated to track which subunits of the second storage device are stale. The subunits have a smaller granularity than the unit of allocation. When the second storage device is available, data on the first storage device is resilvered to the second storage device. Only the subunits that are marked as stale in the data structure are resilvered.

### BACKGROUND

Data storage devices are susceptible to physical failures, and fault tolerant techniques can be employed to avoid or minimize the impact of such failures. In some examples, physical disk drive components may be combined into one or more logical units to provide data redundancy and performance improvement. Data may also be distributed across the drives depending on the desired level of redundancy, performance, reliability, availability, and capacity. Different levels of resiliency can be achieved, for example, by different mirroring schemes or parity schemes.

Mirroring is the replication of data that comprise logical disk volumes to provide redundancy. A mirrored volume may be a logical representation of separate volume copies. Resiliency can be achieved by a mirroring scheme that maintains two copies of data, where the different copies are on one or more different device arrangements. More resiliency can be achieved by having three copies of data on three different device arrangements. The first example can tolerate a single device failure while the second example could tolerate two device failures.

Alternatively, various parity schemes can be used to achieve resiliency. In some examples, a parity drive may be implemented to provide resilience/redundancy. One way to implement parity is to use the exclusive OR (XOR) operation. In such an implementation, the XOR may be performed for data to be backed, and the XOR may be written to the parity drive/volume. If a drive fails, the XOR of the remaining drive and the parity drive can be taken to recover the data on the failed drive. Parity schemes use less disk space than triple mirroring schemes, but may have lower levels of performance because of the need to perform the parity function, as well as other administrative tasks.

It is with respect to these and other considerations that the disclosure made herein is presented. The subject matter claimed herein is not limited to embodiments that solve any disadvantages or that operate only in environments such as those described above. Rather, this background is only provided to illustrate one exemplary technology area where some embodiments described herein may be practiced.

### SUMMARY

It is desirable to provide the highest level of data storage resiliency for handling faults such as power interruptions, while at the same time providing performance and minimizing cost. Two examples of a resiliency mechanism are a mirroring scheme and a parity scheme. When a storage device that is part of a resiliency scheme is taken offline, the storage device will no longer be updated with I/O operations, and thus its storage allocations will become stale with respect to supporting the resiliency scheme. When the storage device is restored, the device must recover changes that were missed while the device was down. The techniques disclosed herein provide for improvements in the time required to recover such devices.

Restoration of a storage volume in a resiliency scheme may be referred to as in-place regeneration or resilvering. In many cases, changes in a storage volume may be tracked allocation units referred to as extents. Such a unit of allocation may typically be, for example, allocated as 1 GB portions. Thus, if it is determined that a 1 GB portion has had a change since a volume has been taken offline, then that portion may be restored in its entirety. However, the restoration of a 1 GB of data may take longer than is desired.

In various embodiments, to improve the mean time to recovery, a smaller level of granularity may be tracked to determine which portions have been changed. Only data in the changed portions need to be restored.

In one embodiment, a change tracking mechanism such as a bitmap may be generated and maintained to track changed portions of a data storage volume. In one embodiment, a data volume may be divided into columns. For example, in a 3-way mirroring scheme, the changes may be tracked in 1 GB chunks or units of allocation. If one of the devices is taken down for servicing, the node will become stale as updates are made to the other active nodes.

In various embodiments described herein, the described bitmap may be used to track the stale portions of a storage volume. The bitmap may then be referred to when a stale device is brought back online, thus allowing for only the bitmapped areas to be updated. The granularity of the bitmap may be varied. For example, one bit in the bitmap may cover a 256 KB area. In one embodiment, the covered area may correspond to the size of a stripe when the storage devices are arranged in a striping scheme.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicates similar or identical items. References made to individual items of a plurality of items can use a reference number with a letter of a sequence of letters to refer to each individual item. Generic references to the items may use the specific reference number without the sequence of letters.

FIG. 1 is a diagram illustrating example resiliency schemes.

FIG. 2 is a diagram illustrating an example of a resiliency scheme, according to the described implementations.

FIG. 3 is a diagram illustrating an example of a resiliency recovery scheme, according to the described implementations.

FIG. 4 is a diagram illustrating an example of using a bitmap to track changes to a device, according to the described implementations.

FIG. 5A is a diagram illustrating an example of a bitmap, according to the described implementations.

FIG. 5B is a diagram illustrating an example of a data structure for storing bitmaps, according to the described implementations.

FIG. 6 is a diagram illustrating an example operational procedure, according to the described implementations.

FIG. 7 is a diagram illustrating an example operational procedure, according to the described implementations.

FIG. 8 is a computer architecture diagram illustrating a computing device architecture for a computing device capable of implementing aspects of the techniques and technologies presented herein.

### DETAILED DESCRIPTION

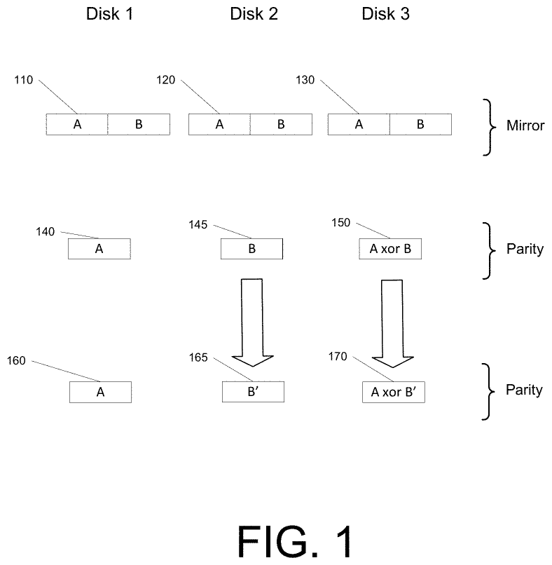

The techniques disclosed herein provide for improvements in the implementation of data resiliency schemes such as mirroring and parity. Many users want the highest level of resiliency when hosting their data, while at the same time providing performance and minimizing cost. Referring to FIG. 1, illustrated are examples of a mirroring scheme and a parity scheme which may be implemented to provide resiliency. Two data blocks A and B are shown initially as data group 110 that may be stored on disk 1. For mirroring with two backups, data blocks A and B are shown replicated as data groups 120 and 130 on disk 2 and disk 3, respectively. In a parity scheme, data blocks A 140 and B 145 are shown on disks 1 and 2, and backed by XOR'ing the data and saved as parity 150. When data B is updated to data B′, then the parity is updated by XOR'ing the updated data B′ and stored as updated parity data 170. It should be noted that the described examples may be implemented in a variety of applicable parity schemes and are not limited to the specific examples described herein. For example, both RAID5 and RAID6 are example scenarios where the described embodiments may be implemented.

As used herein, a node may be a grouping of storage devices for a fault domain. A node may be mirrored to provide resiliency at the node level. More generally, a node may be mirrored so that there are a total of N copies of a node.

In some embodiments, a node may implement a parity-based resiliency scheme to provide resiliency within the node. In other embodiments, the node may implement a mirroring scheme to provide resiliency within the node. Other resiliency schemes may be implemented within the node. As used herein, such a resiliency scheme may also be referred to as a resiliency function or resiliency mechanism. The disclosed embodiments may be implemented in a system configured to provide one or more resiliency schemes, such as Resilient File System (ReFS) by Microsoft.

In some examples, users may implement two or more nodes for resiliency, where a node may be a grouping of storage volumes. For example, a user may implement two nodes that are mirrored for resiliency, where a mirrored copy of the data is maintained in the second node. Each node may have a number of storage devices, such as three disks. Such a resiliency scheme may be referred to as a resiliency layout. In some cases, a node may need to be taken off line for maintenance. However, during such a time, the offline node will not receive any updates. In other examples, users may implement two or more devices for resiliency. For example, a user may implement two storage devices that are mirrored for resiliency, where a mirrored copy of the data is maintained in the second device. In some cases, a device may need to be taken off line for maintenance. However, during such a time, the offline device will not receive any updates.

In an embodiment, when a storage device that has been taken offline is brought back online, the device must be restored and resynchronized and updated with changes that were missed while the device was down. The techniques disclosed herein provide for improvements in the time required to recover such devices.

Restoration of a storage volume in a resiliency scheme may be referred to as in-place regeneration or resilvering. In many cases, changes in a storage volume may be tracked by data portions such as a unit of allocation, for example in 1 GB portions. Thus, if it is determined that a 1 GB unit of allocation has had a change since a volume has been taken offline, then that portion may be restored in its entirety. However, the restoration of a 1 GB of data may take longer than is desired.

In various embodiments, to improve the mean time to recovery, a smaller unit of granularity may be tracked to determine which portions have been changed. Only data in the changed portions need to be restored.

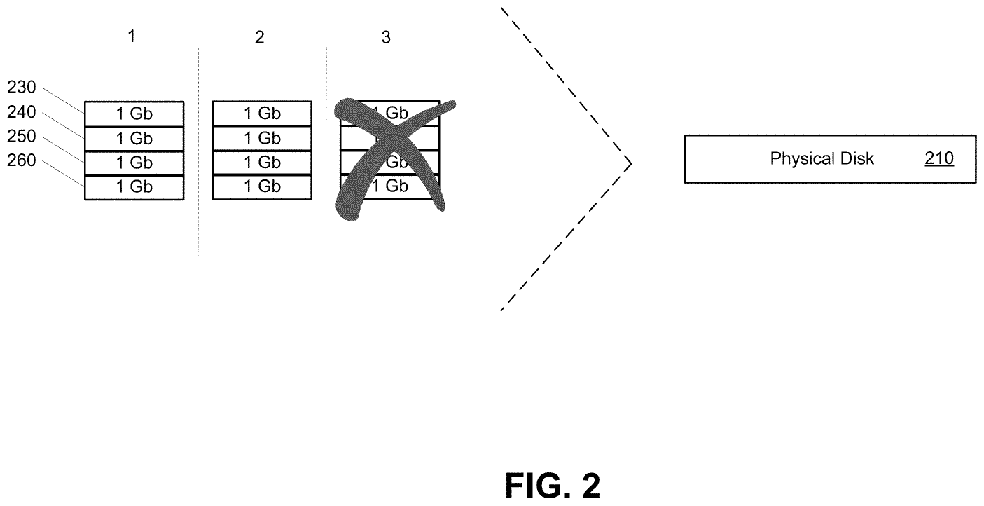

In one embodiment, a change tracking mechanism such as a bitmap may be generated and maintained to track changed portions of a data storage volume. In one embodiment, a data volume may be divided into columns. FIG. 2 illustrates an example of a 3-way mirror implemented as three physical or virtual disks 1, 2, and 3 that are tracked in 1 GB chunks or units of allocation. As used herein, a unit of allocation may be referred to as a physical unit of allocation, which in some examples may be implemented as an extant. In some embodiments, the physical unit of allocation may be a size that is a factor of the size of storage device or volume. In other words, the storage size of the disk or volume is divisible by the physical unit of allocation. Each disk may comprise a number of 1 GB units such as 230, 240, 250, and 260. In this example, the third disk represented by disk 3 is shown as being taken down for servicing. While the third disk is down, the disk will become stale as updates are made to the other active disks 1 and 2. For example, if the first two 1 GB areas have been changed such as 230 and 240, then when disk 3 is brought back online, the first two 1 GB areas 230 and 240 will need to be updated on disk 3. If only the 1 GB areas are tracked as being changed, then the entire two 1 GB areas that were changed will need to be updated on disk 3. This may be inefficient as only a small portion of a given area is typically updated.

In various embodiments, a bitmap may be used to track the stale portions of a storage volume or disk. The bitmap may be referred to when a stale device is brought back online, thus allowing for only the bitmapped areas to be updated. The granularity of the bitmap may be varied. For example, one bit in the bitmap may cover a 256 KB area. In one embodiment, the covered area may correspond to the size of a stripe when the devices are implementing a striping scheme. In general, the granularity of the bitmap may correspond to a subunit of the physical unit of allocation. In some embodiments, the size of the subunit may be a factor of the physical unit of allocation. In other words, the size of the physical unit of allocation is divisible by the subunit. The subunit may be referred to wherein as a storage unit.

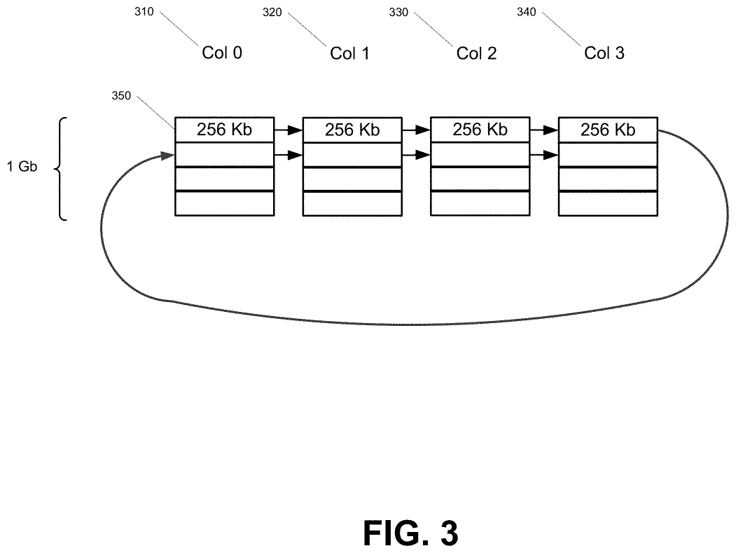

Referring to FIG. 3, illustrated is a four-column storage scheme with column 0 310, column 1 320, column 2 330, and column 3 340, where each column is 1 GB. Each column may comprise 256 KB stripes (e.g., stripe 350) which are written across the four columns that wrap around with applicable virtual offsets. In an embodiment, the bitmap may correspond to the described storage structure, where each bit represents one portion (stripe in this example) of a column. If a write fails to a column, then the trackable subunit (e.g., a 256 KB stripe) that was failed may be tracked in the bitmap. When the column where the write failed subsequently becomes available to be resilvered, then only the affected subunits need to be resilvered. The write may fail for various reasons, such as the underlying device having a hardware issue, or the underlying device having been taken offline. The sizes may vary and may be configurable, but a given physical storage allocation size (e.g., 1 Gb in this example) may be subdivided into a finer level of granularity for change tracking (e.g., the size of a stripe or 256 Kb in this example). Finer levels of granularity may be used, with more bits being needed to represent the bitmap. As the granularity becomes finer (i.e., the size of the storage area covered by one bit of the bitmap), the size of the bitmap will increase. The number of bits needed may be determined as follows:

number of bits=allocation size/subunit size

number of bytes=number of bits/8

size of bitmap in bytes=Allocation size/stripe size*1/8

Thus in the example shown in FIG. 3, 1 GB/256 K*1/8*1

$$= 4096 * 1 / 8 * 1 \\ = 512 bytes$$

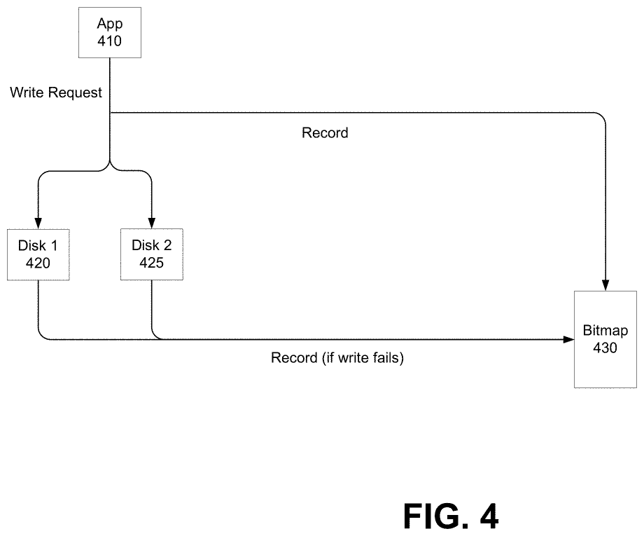

Each time a write is performed, the operation may be tracked by setting a bit in the bitmap. However, this can also be a continuous source of overhead if this is done for each and every write, which may incur a performance cost. In an embodiment, rather than executing a write to the bitmap in response to each and every I/O operation that affects a storage device, the entire allocation (e.g., the entire bitmap) may be initially marked as stale. This would, at the outset, indicate that all portions of the storage area are stale and would need to be updated when an offline device is brought online. On an opportunistic basis, an updated status may be reflected in the bitmap in a way that reduces impact to pending I/O requests. In this way, the I/O performance can be prioritized while updating the bitmap on an opportunistic basis to provide the described recovery efficiency techniques. This is further illustrated in FIG. 4, which shows that write requests to disk 1 420 and disk 2 425 may be recorded in a bitmap data structure 430. In one embodiment, a write request from application 410 may be recorded to the bitmap data structure 430 before the data is attempted to be written to disk 1 420 and disk 2 425. The bitmap may be updated beforehand when is it known that one of the disks is missing or otherwise unavailable. In that case, rather than send the write down to that disk, it can be assumed that the write has already failed to that particular disk and the bitmap may be updated to indicate that the data at the stripe (subunit) is now stale. If the write fails, then the bitmap data structure 240 may be updated to record that the write occurred but failed and is therefore stale. If it is known that either disk 1 420 or disk 2 425 is not responsive because it is down or otherwise not available, then the bitmap data structure 430 may be updated before the write requests are attempted. If writes are sequential and only small chunks are written that are contiguous with one another, sending multiple writes to the bitmap may affect performance.

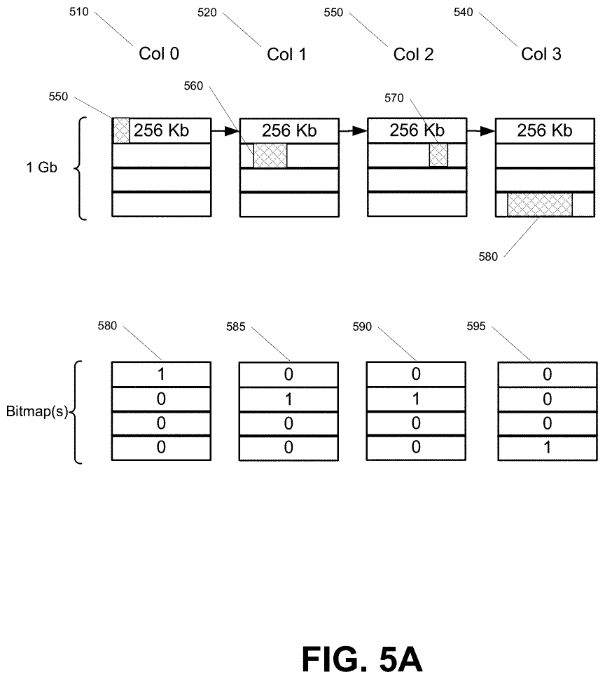

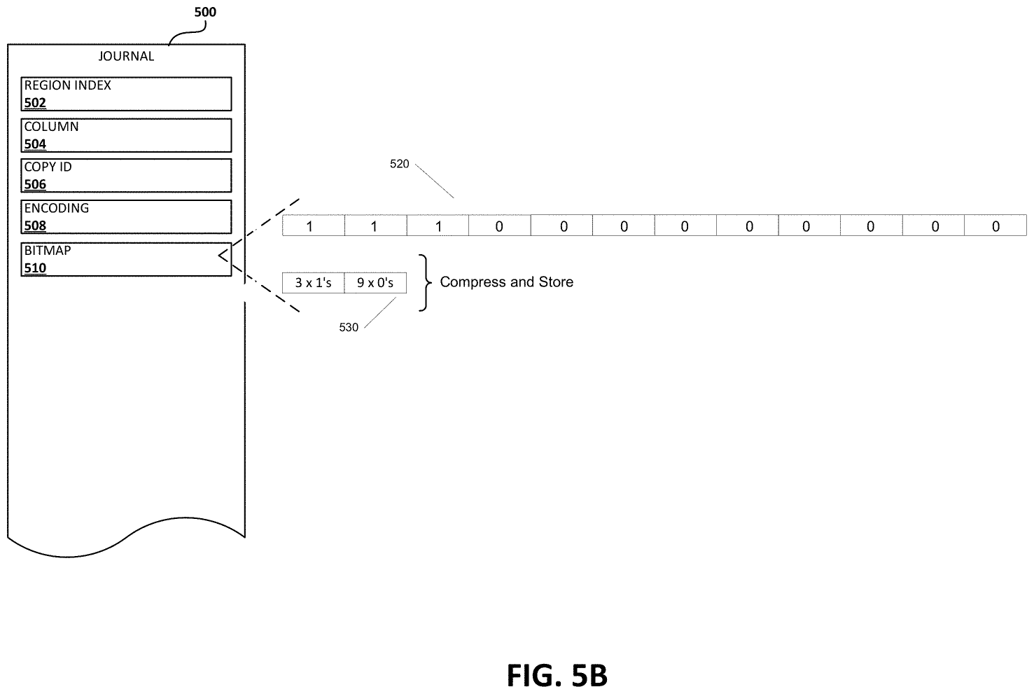

FIG. 5A illustrates a bitmap that is structured based on the four column storage scheme with column 0 510, column 1 520, column 2 530, and column 3 540. The columns are shown with areas that have been modified 550 on column 0 510, area 560 on column 1 520, area 570 on column 2 550, and area 580 on column 3 540. The corresponding areas may be marked in the bitmaps 580, 585, 590, and 595 to correspond to the modified areas. In some embodiments, one bitmap may be allocated per column. This may be advantageous in scenarios where columns are representative of physical allocations, and in some cases a column may be a fault domain. If failures occur within a column, then it may be efficient to use run length encoding or other compression techniques to record long strings of 1's or 0's. In some embodiments, a number of bitmaps may be concatenated or otherwise linked together.

By initially marking the entire bitmap as stale, if volume resilvering is required before the bitmap can be fully updated to reflect unchanged areas, then in some cases more areas will be updated than may be necessary. However, the scheme will fail safe and data integrity will be maintained in this situation. However, the tradeoff may be beneficial by allowing for the bitmap to be maintained as a background process and avoiding the updating of bits in response to every I/O operation, thus reducing impacts to foreground I/O processes. In practice, storage device crashes may be infrequent, and by implementing the described technique, the recovery scheme may be optimized for the majority case where the bitmap is updated opportunistically, configuring the system to fail safe but allowing for performance optimization.

In one embodiment, the following process may be implemented to incorporate the described techniques:

1. in response to a volume or node failure, instantiate a bitmap to record stale subunits (e.g., stripes) on unavailable devices

2. mark the bitmap to indicate the entire volume as stale

3. track I/O operations to active volumes

4. update the bitmap on an opportunistic basis (e.g., when the cache is flushed.

In some embodiments, the bitmap may employ a dirty region tracking (DRT) data structure in cache to track the bits before committing to permanent storage. One issue that may arise is that is there are outstanding I/O operations that are pending in a scenario with two mirrored storage drives that need to be written to, if a crash occurs while the I/O operations are pending, the two mirrored disks may get out of sync. To address this issue, some systems may employ a data structure to track outstanding I/O operations and identify how to resolve conflicts. For example, such a data structure may track outstanding writes for a given region. The data structure may be used to record virtual offsets that have outstanding writes before a write is dispatched. In some embodiments, when systems employ such a data structure, the described bitmap may use the same data structure or may opportunistically use the same mechanism to write to the bitmap, since a write is being incurred for the DRT data structure. Additionally, using the DRT store may be used because only the current and previous states need to tracked. If the current state is committed to the DRT store successfully (i.e., the transaction was successful) then the current state is relevant the next time it is attempted to attach the space. If the current state fails to commit down to the DRT store (i.e., the transaction failed), then the previous good state can be used. This characteristic may be used for tracking both outstanding writes on the space, as well as stale stripes (subunits).

Referring to FIG. 5B, illustrated is an example of a journal 500 that is operable to store a bitmap 510. The bitmap 510 may be associated with a region index 502, and column 504. The region index 502 may be a virtual offset with respect to the corresponding virtual disk. The journal 500 may also include Copy ID field 506. In some embodiments, an entry may be created per extent, and each extent may be represented by a unique ID represented by the following tuple: {REGION INDEX, COLUMN, COPY ID}. In some embodiments, journal 500 may also include an Encoding field 508 that describes how the bitmap is encoded (e.g., run-length encoding).

In some embodiments, the Region Index 502, Column 504, Copy ID 506, Encoding 508, and Bitmap 510 fields may be encapsulated in a single block rather than separating fields into separate blocks that represent an entry. An entry describes the locations of stale data with respect to a given extent in the virtual disk. The example illustrated in FIG. 5B is one example implementation and the representation need not be a bitmap. The representation can be an arbitrary data structure such as an array. More generally, journal 500 may be implemented as a data structure. It will be appreciated by one skilled in the art that the data structure shown in the figure may represent an array, a data file, a database table, an object stored in a computer storage, a programmatic structure or any other data container commonly known in the art. Each data element included in the data structure may represent one or more fields in a data file, one or more columns of a database table, one or more attributes of an object, one or more variables of a programmatic structure or any other unit of data of a data structure commonly known in the art.

As changes are made to storage areas, the bitmaps may be updated to store the changes in the manner described herein. In one embodiment, the bitmap(s) may indicate 1's where stale data resides as a result of a failed write. A bitmap 523 may be readily compressed, for example, by storing the numbers of 0's and 1's and their order in the compressed record 524. These changes may be accumulated, and later concatenated to generate the full updated bitmap.

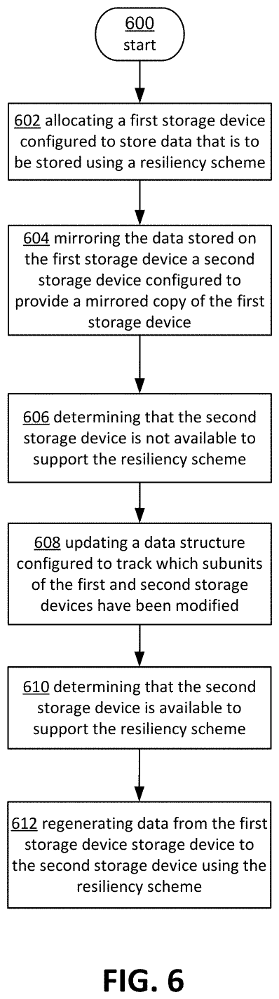

Referring to FIG. 6, illustrated is an example operational procedure in accordance with the present disclosure. It should be understood that the operations of the methods disclosed herein are not presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof

For example, the operations of the routine are described herein as being implemented, at least in part, by modules running the features disclosed herein and can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it can be appreciated that the operations of the routine may be also implemented in many other ways. For example, the routine may be implemented, at least in part, by a processor of another remote computer or a local circuit. In addition, one or more of the operations of the routine may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

Referring to FIG. 6, Operation 600 begins the procedure. Operation 600 may be followed by Operation 602. Operation 602 illustrates allocating a first storage device configured to store data using a resiliency scheme. Operation 602 may be followed by Operation 604. Operation 604 illustrates mirroring the data stored on the first storage device to a second storage device configured to provide a mirrored copy of the first storage device. In an embodiment, write operations to the first and second storage devices are executed based on a physical unit of allocation. Additionally and optionally, write operations to the first and second storage devices are tracked based on a subunit of allocation that has a smaller granularity than the physical unit of allocation. Operation 604 may be followed by Operation 606. Operation 606 illustrates determining that the second storage device is not available to support the resiliency scheme. Operation 606 may be followed by Operation 608. Operation 608 illustrates updating a data structure that is configured to track which subunits of allocation of the first storage device have been modified that were not modified on the second storage device.

Operation 608 may be followed by operation 610. Operation 610 illustrates determining that the second storage device is available to support the resiliency scheme and needs to be synchronized with the first storage device. Operation 610 may be followed by operation 612. Operation 612 illustrates regenerating data from the first storage device to the second storage device using the resiliency scheme, wherein only the subunits of allocation indicated as stale in the data structure are regenerated.

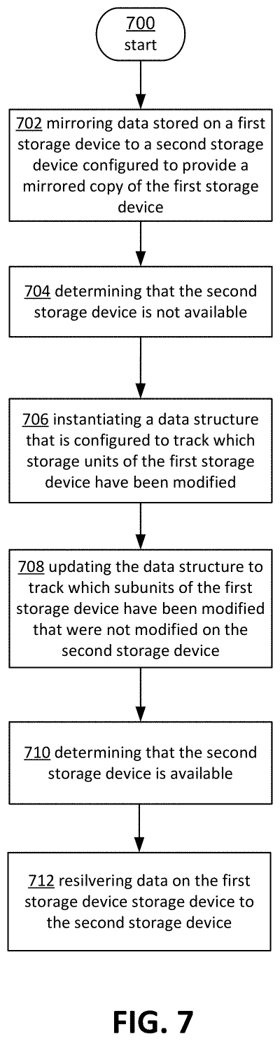

Referring to FIG. 7, illustrated is an example operational procedure in accordance with the present disclosure. Referring to FIG. 7, Operation 700 begins the procedure. Operation 700 may be followed by Operation 702. Operation 702 illustrates mirroring data stored on a first storage device to a second storage device configured to provide a mirrored copy of the first storage device. In an embodiment, writes to the first and second storage devices are performed based on a unit of allocation. Operation 702 may be followed by Operation 704. Operation 704 illustrates determining that the second storage device is not available. Operation 704 may be followed by Operation 706. Operation 706 illustrates instantiating a data structure that is configured to track which subunits of the first storage device have been modified that were not modified on the second storage device. In an embodiment, the subunits have a smaller granularity than the unit of allocation.

Operation 706 may be followed by Operation 708. Operation 708 illustrates updating the data structure to track which subunits of the first storage device have been modified that were not modified on the second storage device. Operation 708 may be followed by Operation 710. Operation 710 illustrates determining that the second storage device is available. Operation 710 may be followed by Operation 712. Operation 712 illustrates resilvering data on the first storage device to the second storage device. In an embodiment, only the subunits indicated in the data structure as stale are resilvered.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof

For example, the operations of the described methods are described herein as being implemented, at least in part, by system components, which can comprise an application, component and/or a circuit. In some configurations, the system components include a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of FIG. 1-7, it can be appreciated that the operations of the described methods may be also implemented in many other ways. For example, the methods may be implemented, at least in part, by a processor of another remote computer or a local circuit. In addition, one or more of the operations of the methods may alternatively or additionally be implemented, at least in part, by a chipset working alone or in conjunction with other software modules. Any service, circuit or application suitable for providing the techniques disclosed herein can be used in operations described herein.

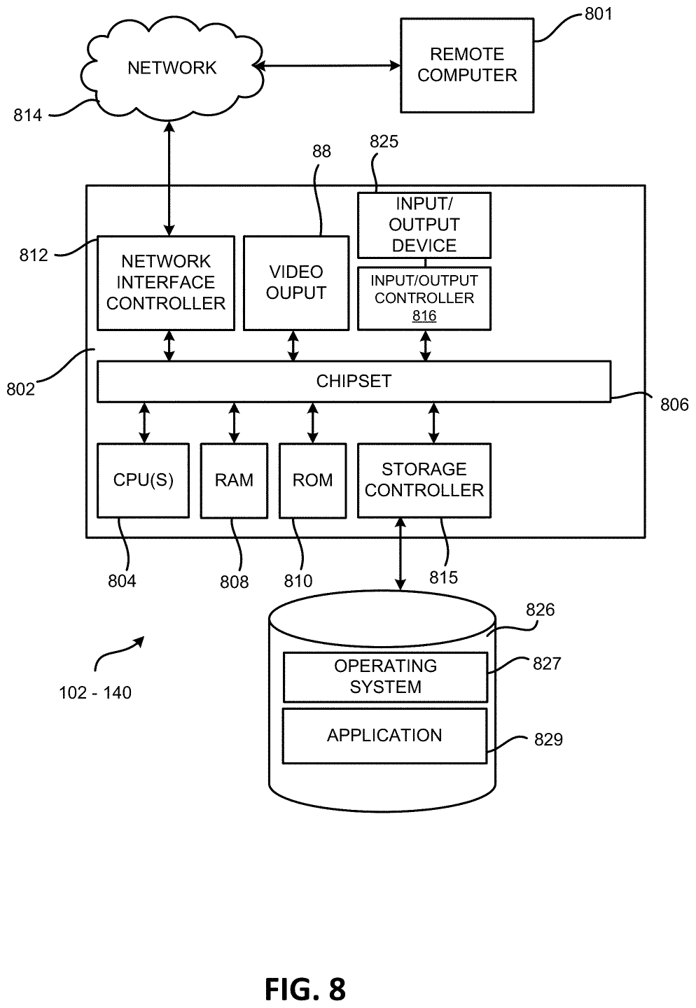

FIG. 8 shows additional details of an example computer architecture capable of various aspects of the embodiments described above. The computer architecture shown in FIG. 8 illustrates aspects of a system, such as a conventional server computer, workstation, desktop computer, laptop, tablet, computing or processing systems embedded in devices (such as wearables, automobiles, home automation etc.), or other computing device, and may be utilized to execute any of the software components presented herein. For example, the computer architecture shown in FIG. 8 may be utilized to execute any of the software components described above.

The computer architecture includes a baseboard 802, or “motherboard,” which is a printed circuit board to which a multitude of components or devices may be connected by way of a system bus or other electrical communication paths. In one illustrative embodiment, one or more central processing units (“CPUs”) 804 operate in conjunction with a chipset 806. The CPUs 804 may be standard programmable processors that perform arithmetic and logical operations necessary for the operation of the computer architecture.

The CPUs 804 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a RAM 808, used as the main memory in the computer architecture. The chipset 806 may further provide an interface to a computer-readable storage medium such as a read-only memory (“ROM”) 810 or non-volatile RAM (“NVRAM”) for storing basic routines that help to startup the computing device and to transfer information between the various components and devices. The ROM 810 or NVRAM may also store other software components necessary for the operation of the computer architecture in accordance with the embodiments described herein.

The computer architecture may operate in a networked environment using logical connections to remote computing devices and computer systems through a network 814, such as the local area network. The chipset 806 may include functionality for providing network connectivity through a network interface controller (NIC) 88, such as a gigabit Ethernet adapter. The NIC 88 is capable of connecting the computer architecture to other computing devices over the network 814. It should be appreciated that multiple NICs 88 may be present in the computer architecture, connecting the computer to other types of networks and remote computer systems. The network allows the computer architecture to communicate with remote services and servers, such as the remote computer 801. As can be appreciated, the remote computer 801 may host a number of services such as the XBOX LIVE gaming service provided by MICROSOFT CORPORATION of Redmond, Wash. In addition, as described above, the remote computer 801 may mirror and reflect data stored on the computer architecture and host services that may provide data or processing for the techniques described herein.

The computer architecture may be connected to a mass storage device 826 that provides non-volatile storage for the computing device. The mass storage device 826 may store system programs, application programs, other program modules, and data, which have been described in greater detail herein. The mass storage device 826 may be connected to the computer architecture through a storage controller 815 connected to the chipset 806. The mass storage device 826 may consist of one or more physical storage units. The storage controller 815 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 826, other storage media and the storage controller 815 may include MultiMediaCard (MMC) components, eMMC components, Secure Digital (SD) components, PCI Express components, or the like.

The computer architecture may store data on the mass storage device 826 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 826 is characterized as primary or secondary storage, and the like.

For example, the computer architecture may store information to the mass storage device 826 by issuing instructions through the storage controller 815 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer architecture may further read information from the mass storage device 826 by detecting the physical states or characteristics of one or more particular locations within the physical storage units.

In addition to the mass storage device 826 described above, the computer architecture may have access to other computer-readable media to store and retrieve information, such as program modules, data structures, or other data. As the operating system 827, the application 829, other data and other modules are depicted as data and software stored in the mass storage device 826, it should be appreciated that these components and/or other modules may be stored, at least in part, in other computer-readable storage media of the computer architecture. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture. For purposes of the claims, the phrase “computer storage medium,” “computer-readable storage medium,” and variations thereof, does not include waves or signals per se and/or communication media.

The mass storage device 826 may store an operating system 827 utilized to control the operation of the computer architecture. According to one embodiment, the operating system comprises a gaming operating system. According to another embodiment, the operating system comprises the WINDOWS® operating system from MICROSOFT Corporation. According to further embodiments, the operating system may comprise the UNIX, ANDROID, WINDOWS PHONE or iOS operating systems, available from their respective manufacturers. It should be appreciated that other operating systems may also be utilized. The mass storage device 826 may store other system or application programs and data utilized by the computer architecture, such as any of the other software components and data described above. The mass storage device 826 might also store other programs and data not specifically identified herein.

In one embodiment, the mass storage device 826 or other computer-readable storage media is encoded with computer-executable instructions which, when loaded into the computer architecture, transform the computer from a general-purpose computing system into a special-purpose computer capable of implementing the embodiments described herein. These computer-executable instructions transform the computer architecture by specifying how the CPUs 804 transition between states, as described above. According to one embodiment, the computer architecture has access to computer-readable storage media storing computer-executable instructions which, when executed by the computer architecture, perform the various routines described above with regard to FIG. 8, and the other FIGURES. The computing device might also include computer-readable storage media for performing any of the other computer-implemented operations described herein.

The computer architecture may also include one or more input/output controllers 816 for receiving and processing input from a number of input devices, such as a keyboard, a mouse, a microphone, a headset, a touchpad, a touch screen, an electronic stylus, image processing and gesture recognition devices, or any other type of input device. The input/output controller 816 is in communication with an input/output device 825. The input/output controller 816 may provide output to a display, such as a computer monitor, a flat-panel display, a digital projector, a printer, a plotter, or other type of output device. The input/output controller 816 may provide input communication with other devices such as a microphone, a speaker, game controllers and/or audio devices.

For example, the input/output controller 816 can be an encoder and the input/output device 825 can include a full speaker system having a plurality of speakers. The encoder can use a spatialization technology, and the encoder can process audio output audio or output signals received from the application 88. The encoder can utilize a selected spatialization technology to generate a spatially encoded stream that appropriately renders to the input/output device 825.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The disclosure presented herein may be considered in view of the following clauses.

Example Clause A, a computer-implemented method for storing data in a storage system, the method comprising:

allocating a first storage device configured to store data using a resiliency scheme;

mirroring the data stored on the first storage device to a second storage device configured to provide a mirrored copy of the first storage device, wherein:

write operations to the first and second storage devices are executed based on a physical unit of allocation, and

write operations to the first and second storage devices are tracked based on a subunit of allocation that has a smaller granularity than the physical unit of allocation;

determining that the second storage device is not available to support the resiliency scheme;

updating a data structure that is configured to track which subunits of allocation of the first storage device have been modified that were not modified on the second storage device;

determining that the second storage device is available to support the resiliency scheme and needs to be synchronized with the first storage device; and
regenerating data from the first storage device to the second storage device using the resiliency scheme, wherein only the subunits of allocation indicated as stale in the data structure are regenerated.

Example Clause B, the computer-implemented method of Example Clause A, wherein the data structure is a bitmap.

Example Clause C, the computer-implemented method of any one of Example Clauses A through B, further comprising mirroring the data on a third storage device.

Example Clause D, the computer-implemented method of any one of Example Clauses A through C, wherein the physical unit of allocation is an extent and the subunit of allocation is a stripe.

Example Clause E, the computer-implemented method of any one of Example Clauses A through D, wherein the resiliency scheme comprises striping, and a size of the subunit of allocation corresponds to a size of a stripe.

Example Clause F, the computer-implemented method of any one of Example Clauses A through E, further comprising:

initializing the data structure to mark an entire physical unit of allocation as stale; and

updating the data structure to indicate which subunits are not stale on an opportunistic basis.

Example Clause G, the computer-implemented method of any one of Example Clauses A through F, wherein the data structure is implemented in conjunction with a dirty region tracking data structure.

Example Clause H, a computing device comprising:
one or more processors;
a memory in communication with the one or more processors, the memory having computer-readable instructions stored thereupon which, when executed by the one or more processors, cause the computing device perform operations comprising:

mirroring data stored on a first storage device to a second storage device configured to provide a mirrored copy of the first storage device, wherein writes to the first and second storage devices are performed based on a unit of allocation;

determining that the second storage device is not available;

instantiating a data structure that is configured to track which subunits of the first storage device have been modified that were not modified on the second storage device, wherein the subunits have a smaller granularity than the unit of allocation;

updating the data structure to track which subunits of the first storage device have been modified that were not modified on the second storage device;

determining that the second storage device is available; and

resilvering data on the first storage device to the second storage device, wherein only

the subunits indicated in the data structure as stale are resilvered.

Example Clause I, the computing device of Example Clause H, wherein the data structure is a bitmap.

Example Clause J, the computing device of any one of Example Clauses H through I, further comprising mirroring the data on a third storage device.

Example Clause K, the computing device of any one of Example Clauses H through J, wherein the data structure is maintained in a cache and written to permanent storage when the cache is flushed.

Example Clause L, the computing device of any one of Example Clause H through K, wherein the mirroring comprises striping, and a size of the subunits corresponds to a size of a stripe.

Example Clause M, the computing device of any one of Example Clauses H through L, further comprising:

initializing the data structure to mark an entire unit of allocation as stale; and

updating the data structure to indicate which subunits are not stale on an opportunistic basis.

Example Clause N, the computing device of any one of Example Clauses H through L, wherein the data structure is implemented in conjunction with a dirty region tracking data structure.

Example Clause O, a computer-readable medium having encoded thereon computer-executable instructions that, when executed, cause one or more processing units of a computing device to execute a method comprising:

configuring a first storage device and a second storage device to store data using a resiliency scheme, wherein writes to the first and second storage devices are executed based on a unit of allocation;

determining that the second storage device is not available to support the resiliency scheme;

updating a data structure that is configured to track subunits of the first storage device that have been modified that were not synchronized with the second storage device, wherein the subunits have a smaller granularity than the unit of allocation;

determining that the second storage device is available to support mirroring; and

regenerating data on the second storage device based on the first storage device, wherein only the subunits indicated in the data structure as stale are regenerated.

Example Clause P, the computer-implemented method of Example O, wherein the data structure is a bitmap.

Example Clause Q, the computer-implemented method of any one of Example Clauses O through P, further comprising mirroring the data on a third storage device.

Example Clause R, the computer-implemented method of any one of Example Clauses O through Q, wherein the data structure is maintained in a cache and written to permanent storage when the cache is flushed.

Example Clause S, the computer-implemented method of any one of Example Clauses O through R, wherein the mirroring comprises striping, and a size of the subunits corresponds to a size of the stripe.

Example Clause T, the computer-implemented method of any one of Example Clauses O through S, further comprising:

initializing the data structure to mark an entire unit of allocation as stale; and

updating the data structure to indicate which subunits of the entire unit of allocation are not stale on an opportunistic basis.

1. A computer-implemented method for storing data in a storage system, the method comprising:
allocating a first storage device configured to store data using a resiliency scheme;
mirroring the data stored on the first storage device to a second storage device configured to provide a mirrored copy of the first storage device, wherein:
write operations to the first and second storage devices are executed based on a physical unit of allocation, and
write operations to the first and second storage devices are tracked based on a subunit of allocation that has a smaller granularity than the physical unit of allocation;
determining that the second storage device is not available to support the resiliency scheme;
initializing a data structure that is configured to track which subunits of allocation of the first storage device have been modified that were not modified on the second storage device, wherein the data structure is initialized to mark an entire physical unit of allocation as stale;
updating the data structure to indicate which subunits are not stale on an opportunistic basis;
determining that the second storage device is available to support the resiliency scheme and needs to be synchronized with the first storage device; and
regenerating data from the first storage device to the second storage device using the resiliency scheme, wherein only the subunits of allocation indicated as stale in the data structure are regenerated.

2. The computer-implemented method of claim 1, wherein the data structure is a bitmap.

3. The computer-implemented method of claim 1, further comprising mirroring the data on a third storage device.

4. The computer-implemented method of claim 1, wherein the physical unit of allocation is an extent and the subunit of allocation is a stripe.

5. The computer-implemented method of claim 1, wherein the resiliency scheme comprises striping, and a size of the subunit of allocation corresponds to a size of a stripe.

6. The computer-implemented method of claim 1, further comprising:
initializing the data structure to mark an entire physical unit of allocation as stale; and
updating the data structure to indicate which subunits are not stale on an opportunistic basis.

7. The computer-implemented method of claim 1, wherein the data structure is implemented in conjunction with a dirty region tracking data structure.

8. A computing device comprising:
one or more processors;
a memory in communication with the one or more processors, the memory having computer-readable instructions stored thereupon which, when executed by the one or more processors, cause the computing device to perform operations comprising:
mirroring data stored on a first storage device to a second storage device configured to provide a mirrored copy of the first storage device, wherein writes to the first and second storage devices are performed based on a unit of allocation;
determining that the second storage device is not available;
instantiating a data structure that is configured to track which subunits of the first storage device have been modified that were not modified on the second storage device, wherein the subunits have a smaller granularity than the unit of allocation, and wherein the data structure is initialized to mark an entire unit of allocation as stale;
updating the data structure to indicate which subunits are not stale on an opportunistic basis;
determining that the second storage device is available; and
resilvering data on the first storage device to the second storage device, wherein only the subunits indicated in the data structure as stale are resilvered.

9. The computing device of claim 8, wherein the data structure is a bitmap.

10. The computing device of claim 8, further comprising mirroring the data on a third storage device.

11. The computing device of claim 8, wherein the data structure is maintained in a cache and written to permanent storage when the cache is flushed.

12. The computing device of claim 8, wherein the mirroring comprises striping, and a size of the subunits corresponds to a size of a stripe.

13. The computing device of claim 8, further comprising:
initializing the data structure to mark an entire unit of allocation as stale; and
updating the data structure to indicate which subunits are not stale on an opportunistic basis.

14. The computing device of claim 8, wherein the data structure is implemented in conjunction with a dirty region tracking data structure.

15. A non-transitory computer-readable medium having encoded thereon computer-executable instructions that, when executed, cause one or more processing units of a computing device to execute a method comprising:
configuring a first storage device and a second storage device to store data using a resiliency scheme, wherein writes to the first and second storage devices are executed based on a unit of allocation;
determining that the second storage device is not available to support the resiliency scheme;
initializing a data structure that is configured to track which subunits of allocation of the first storage device have been modified that were not modified on the second storage device, wherein the data structure is initialized to mark an entire physical unit of allocation as stale;
updating the data structure to indicate which subunits are not stale on an opportunistic basis, wherein the subunits have a smaller granularity than the unit of allocation;
determining that the second storage device is available to support mirroring; and
regenerating data on the second storage device based on the first storage device, wherein only the subunits indicated in the data structure as stale are regenerated.

16. The computer-readable medium of claim 15, wherein the data structure is a bitmap.

17. The computer-readable medium of claim 15, further comprising mirroring the data on a third storage device.

18. The computer-readable medium of claim 15, wherein the data structure is maintained in a cache and written to permanent storage when the cache is flushed.

19. The computer-readable medium of claim 15, wherein the mirroring comprises striping, and a size of the subunits corresponds to a size of the stripe.

20. The computer-readable medium of claim 15, further comprising:
initializing the data structure to mark an entire unit of allocation as stale; and
updating the data structure to indicate which subunits of the entire unit of allocation are not stale on an opportunistic basis.
